(19) United States
(12) Patent Application Publication
(10) Pub. No.: US 2005/0141426 A1
(43) Pub. Date: Jun. 30, 2005

(54) System and method for controlling packet transmission using a plurality of buckets

(75) Inventor: Cheng-Liang Hou, Kaohsiung City (TW)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/748,223

(22) Filed: Dec. 31, 2003

(51) Int. Cl. H04L 12/28

(52) U.S. Cl. 370/235; 370/412

(57) ABSTRACT

The system and method control packet behavior by incrementing buckets associated with packet type and decrementing one bucket when a packet type associated with that bucket is transmitted. If a bucket count falls below a threshold value, an associated packet is dropped.

### BACKGROUND OF THE INVENTION

1. Technical Field

This invention relates generally to switches, and more particularly, but not exclusively, to packet transmission behavior based on packet type and implemented with a plurality of buckets at each port.

2. Description of the Related Art

Networks, such as local area networks (i.e., LANs) and wide area networks (i.e., WANs, e.g., the Internet), enable a plurality of nodes to communicate with each other. Nodes can include computers, servers, storage devices, mobile devices, PDAs, wireless telephones, etc. Networks can include the nodes themselves, a connecting medium (wired, wireless and/or a combination of wired and wireless), and network switching systems such as routers, hubs and/or switches.

The transmission of packets in network switching systems can be conventionally controlled through the use of token buckets or leaky buckets. These buckets have a threshold level and a maximum capacity level. The buckets are incremented at a constant rate until maximum capacity is reached and decremented whenever a packet is transmitted. The increment rate corresponds with the transmission rate of the network switching system. Accordingly, if the bucket level falls below a threshold level, packets are dropped and/or other corrective action is taken (e.g., a pause on packet is transmitted to a network node causing congestion) as this indicates a high usage/congestion level.

However, a disadvantage of this conventional control mechanism is that it does not distinguish between types of packets. In other words, the mechanism treats unicast, broadcast, multicast, address resolution protocol (ARP) packet types and other packet types equally. Accordingly, if a network node is flooding a network switching system with multicast or broadcast packets, as in a broadcast storm, it can monopolize that system and cause other packets, which may be more important, to be dropped because of the congestion. Accordingly, a new system and method are needed that can overcome this disadvantage.

### SUMMARY OF THE INVENTION

Embodiments of the invention overcome the disadvantage by controlling packet behavior by packet type. When an excessive number of packets of a first type are received, embodiments of the invention will drop only packets of this first type. Packets having a different type will not be dropped, thereby preventing packets of the first type from monopolizing a network switching system.

In an embodiment of the invention, the method comprises: setting a plurality of packet type filters so that each filters for a different packet type; incrementing a plurality of buckets, wherein each bucket communicatively coupled to a packet type filter of the plurality of filters; receiving a packet having a packet type; measuring the bucket that is coupled to the packet type filter that filters for the received packet type; and transmitting the packet if its measured bucket is above a threshold value.

In an embodiment of the invention, the system comprises a packet receiving engine, a plurality of buckets, a bucket updating engine, and a packet handling engine. The packet receiving engine receives packets of at least a first and second type. Each bucket is communicatively coupled to the packet receiving engine and to a packet type filter from a plurality of packet type filters. Each packet type filter can be set to filter at least one packet type. The bucket updating engine, which is communicatively coupled to the packet receiving engine, increments a first bucket and a second bucket. The packet handling engine, which is communicatively coupled to the packet receiving engine, measures the bucket coupled to the packet type filter that filters for the type of packet received and transmits the received packet if the measured bucket is above a threshold value.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the present invention;

FIG. 2 is a block diagram illustrating a subsection of a rate control system;

FIG. 3 is a block diagram illustrating a packet type filter;

FIG. 4 is a block diagram illustrating a bucket;

FIG. 5 is a block diagram illustrating registers used to implement the bucket;

FIG. 6 is a block diagram illustrating a bucket engine used to control the packet transmission behavior at each port; and

FIG. 7 is a flowchart illustrating a method of controlling packet transmission.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

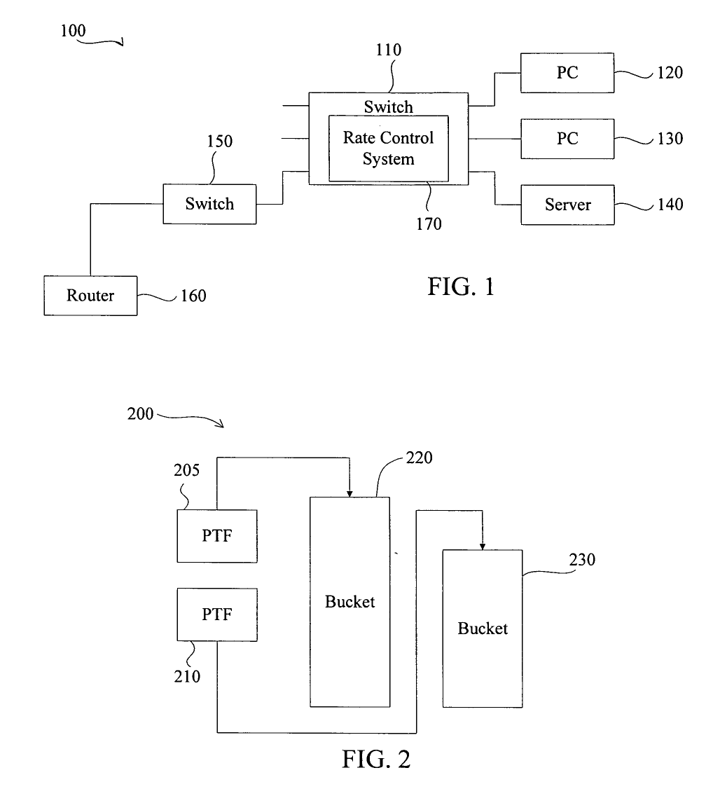

FIG. 1 is a block diagram illustrating a network system 100 in accordance with an embodiment of the present invention. The network system 100 includes 6 nodes: PCs 120 and 130, a server 140, a switch 110, a switch 150, and a router 160. The switch 150, the PC 120 and 130, and the server 140 are each communicatively coupled, via wired or wireless techniques, to the switch 110. The router 160 is communicatively coupled, via wired or wireless techniques, to the switch 150. It will be appreciated by one of ordinary skill in the art that the network system 100 can include additional or fewer nodes and that the network system 100 is not limited to the types of nodes shown. For example, the switch 110 can be further communicatively coupled to network clusters or other networks, such as the Internet.

The rate control system 170, whose components will be discussed further below, comprises a plurality of subsystems, one for each ingress port. Each of the subsystems separately filters different packet types for each ingress port and will drop packets of a certain type (or take other action) if their transmission is determined to be causing congestion or is otherwise deemed excessive. For example, if an ingress port for the network node 140 receives an excessive number of multicast packets, the associated subsystem will start dropping these packets once a threshold is reached. However, ARP packets or other types of packets will not be affected by the dropping of the multicast packets. Accordingly, transmission of a large number of one type of packets, as in a broadcast storm, will not decrease the ability of the ingress port to transmit other types of packets.

FIG. 2 is a block diagram illustrating a subsection 200 of the rate control system 170. Each subsystem of the rate control system 170 includes a subsection 200. The subsection 200 includes two packet type filters (PTFs) and two leaky buckets. Specifically, a PTF 205 is communicatively coupled to a bucket 220 and a PTF 210 is communicatively coupled to a bucket 230. In an embodiment of the invention, the subsection 200 includes additional PTFs and/or buckets.

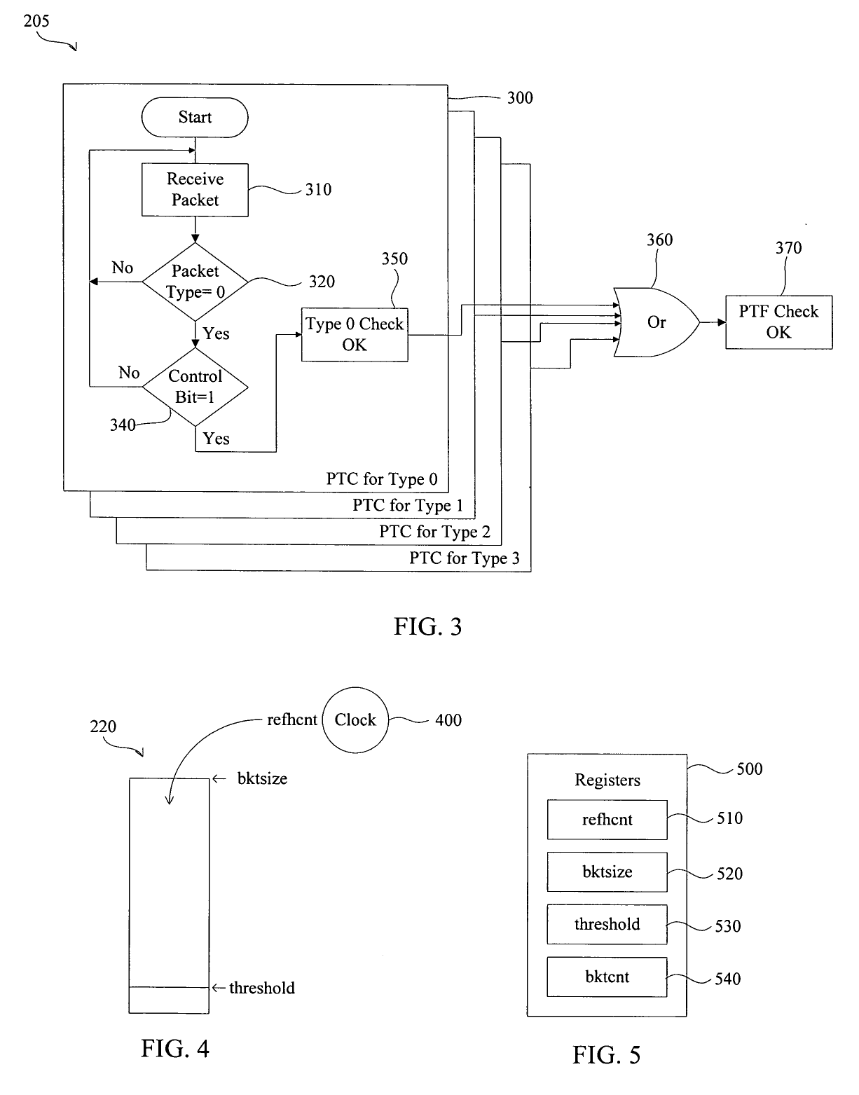

The PTFs 205 and 210, as will be discussed in further detail in conjunction with FIG. 3 below, filter packets by type (which can include quality of service (QOS) levels). For example, the PTF 205 may filter unicast packets while the PTF 210 may filter multicast packets. In another example, the PTF 205 filters packets with a high QOS level while the PTF 210 filters packets with a low QOS level. In another embodiment of the invention, each PTF can filter more than one type of packet. In another embodiment of the invention, each PTF has a selective capability of filtering a plurality of packets (e.g., each PTF can be toggled on or off for filtering different packet types). Once a packet has been filtered, e.g., determined to be of a certain type, an associated bucket is then decremented with the length of the filtered packet (or a token). For example, if PTF 205 filters for unicast packets, the bucket 220 will be decremented with the length of a filtered unicast packet. If PTF 210 filters for multicast packets, the bucket 230 will be decremented with the length of a filtered multicast packet. Accordingly, a bucket can be associated with a packet type by setting the communicatively coupled PTF to filter for that packet type.

As will be discussed in further detail in conjunction with FIG. 4 and FIG. 5 below, the buckets 220 and 230 are incremented at the same fixed rates. In another embodiment of the invention, the buckets 220 and 230 are incremented at different rates. For example, the bucket 220 may be incremented at a faster rate than the bucket 230 to increase the likelihood of transmission of packets associated with the bucket 220 with respect to packets associated with the bucket 230. If a bucket is decremented faster than it is being incremented, then the bucket count will decrease indicating excessive usage, congestion, etc. If a threshold level is reached within a bucket, then packets associated with that bucket will be dropped or other corrective action can be taken. For example, if the bucket 220 count is decremented to a threshold level, unicast packets may be dropped but multicast packets will not be affected. If the bucket 230 count is decremented to a threshold level, then multicast packets may be dropped while unicast packets will be unaffected. In this way, the rate control system 170 enables packet traffic control based on packet type thereby preventing a single packet type from monopolizing an ingress port.

The buckets 220 and 230 can be of equal or different sizes. For example the bucket 220 can be larger than the bucket 230. Accordingly, the threshold level in bucket 230 may be reached quicker than in the bucket 220 all else being equal. The sizes of the buckets 220 and 230 can also be varied (need not be fixed). The buckets 220 and 230 will be discussed in further detail below in conjunction with FIG. 4 and FIG. 5.

FIG. 3 is a block diagram illustrating the packet type filter 205. It will be appreciated by one of ordinary skill in the art that the PTF 210 is substantially similar to the PTF 205. The PTF 205 includes a plurality of packet type checkers (PTCs), such as a PTC 300. Each PTC checks for a single type of packet when activated by a control bit. For example, the PTC 300, when activated, checks for packets of type 0 (e.g., unicast or high QOS). In an embodiment of the invention, several PTCs in a PTF can be activated and therefore check for a plurality of packet types. In other words, each PTC of a PTF can be toggled on and off.

Each PTC can be implemented as an Application Specific Integrated Circuit (ASIC), as software, or via other techniques. During operation, the PTC 300 receives (310) a packet and then checks (320) if it is a packet of type 0. If it is not a type 0 packet, then the PTC 300 receives (310) another packet and repeats the process. If it is a type 0 packet, then the PTC 300 checks if it is activated (340) by checking the setting of a control bit. If the PTC 300 is not active, then the PTC 300 receives (310) another packet and repeats the above. Otherwise, if it is a type 0 packet, then the result is input into an Or gate 360 with results from other PTCs. Since gate 360 is an or gate, a PTF check 370 will indicate OK if at least one of the outputs from the PTCs is true. The associated bucket (e.g., the bucket 220) can then be decremented by the received packet length for each activated PTC (or by a token). For example, a received type 0 packet length can be deducted from the bucket 220 count as can a received type 3 packet length if the associated packet checker in the PTF 205 is activated. It will be appreciated by one of ordinary skill in the art that the PTC 300 can perform the above in a different order than recited above.

FIG. 4 is a block diagram illustrating the bucket 220. The bucket 220 can be a leaky bucket, token bucket, or other bucket type. It will be appreciated by one of ordinary skill in the art that the bucket 230 is substantially similar to the bucket 220. The bucket 220 has a bucket size (bktsize) that can be adjusted according to a network system 100 operator's preferences. For example, if an operator prefers transmission of one packet type over another (e.g., ARP over multicast), the operator can set the bktsize of a bucket associated with ARP packet to a higher number than other buckets. Because it will then take longer to decrement the bucket from the maximum bucket count (bktcnt) equal to the bktsize, it will take longer until a minimum threshold is reached and therefore packets dropped.

The bucket 220 is incremented by a value refhcnt per clock 400 cycle (or other time period) up until the bktcnt reaches the bktsize. In an embodiment of the invention, refhcnt can be varied according to the network system 100 operator's preference or other variables. For example, if an operator prefers the transmission of packets associated with the bucket 220 over packets associated with the bucket 230, the operator can set refhcnt to a higher value for the bucket 220 than for the bucket 230. Accordingly, assuming all else is constant, it will take longer to decrement the bktcnt for the bucket 220 to the threshold value than it would to decrement the bktcnt for the bucket 230 to the threshold value, therefore making it less likely to drop packets associated with the bucket 220 than the bucket 230.

The bucket 220 is also decremented until the bktcnt equals zero. The amount of the decrement is equal to the length of a packet (or a token in a token bucket). Once the bktcnt reaches a threshold value, packets are dropped or other corrective action is taken. The threshold value, like the bktsize, can be set by a network system 100 operator per his or her preferences. If an operator prefers the transmission of packets associated with the bucket 220 over packets associated with the bucket 230 then the threshold in the bucket 220 can be set lower than the threshold in the bucket 230. Accordingly, assuming all else is constant, it will take longer to reach the threshold in the bucket 220 than in the bucker 230 and therefore it will take longer until a packet needs to be dropped.

FIG. 5 is a block diagram illustrating registers 500 used to implement the bucket 220. It will be appreciated by one of ordinary skill in the art that registers substantially similar to the registers 500 can be used to implement the bucket 230 and other buckets. An operator can modify the behavior of the rate control system 170 by modifying the registers 500. The registers 500 include a refhcnt register 510, a bktsize register 520, a threshold register 530, and a bktcnt register 540. The refhcnt register 510 holds the value that the bucket 220 is incremented by. The bktsize register 520 holds the value indicating the size of the bucket 220 and can define the burst size. Example values of the bktsize register 520 include 6 kilobytes (KB), 10 KB, 18 KB, 34 KB, 66 KB, and 130 KB. The threshold register 530 holds the value indicating the threshold of the bucket 220 at which point packets are dropped. In one embodiment of the invention, the threshold register 530 can be fixed at 2047 bytes. The bktcnt register 540 holds the current value of the bucket 220, which fluctuates between 0 and the value stored in the bktsize register 520.

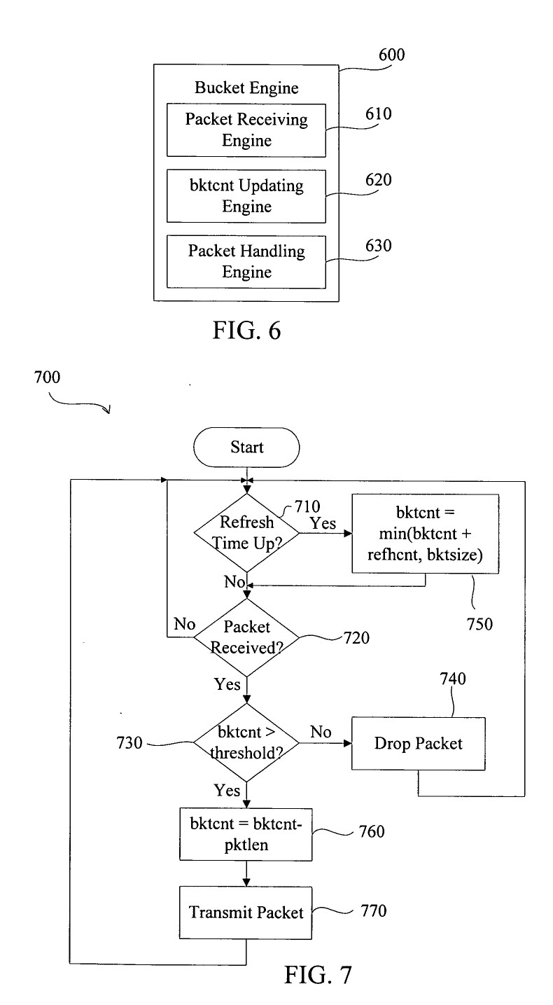

FIG. 6 is a block diagram illustrating a bucket engine 600 used to control the packet transmission behavior at each port and is part of the rate control system 170. Each port can have its own bucket engine 600 or a single bucket engine 600 can be universal and used for all ports. The bucket engine 600 can be implemented as software, an ASIC, or via other technique. The bucket engine 600 comprises a packet receiving engine 610, a bktcnt updating engine 620 and a packet handling engine 630. The packet receiving engine 610 receives packets and feeds the packets into the PTFs 205 and 210 for filtering.

The bktcnt updating engine 620 increments the buckets 220 and 230 (i.e., increments the value stored in the bktcnt register 540) with a value stored in the refhcnt 510 register during every clock cycle (or other time period) up until the buckets 220 and 230 reach their respective bktsize as stored in the bktsize register 520. The bktcnt updating engine 620 also decrements the buckets 220 and 230 (by decrementing the value stored in the bktcnt register 540) by the length of the received packets according to results of the PTF (or by a token if the bucket 220 includes a token bucket). For example, if the PTF 205 indicates a positive result (i.e., a received packet is the type of packet that the PTF 205 is looking for), then the corresponding bucket 220 will be decremented. If the PTF 205 indicates a negative result, then the corresponding bucket 220 will not be decremented by the packet length. Note that if the bktcnt falls below the threshold and the packet is dropped, the bktcnt need not be decremented. The bktcnt updating engine 620 operates similarly with respect to the PTF 210 and the corresponding bucket 230.

The packet handling engine 630 either transmits a received packet to the destination or drops the packet (or takes other corrective action) based on the value of the bucket (e.g., the value of the bktcnt register 540) after a bucket (e.g., the bucket 220) is updated by the bktcnt updating engine 620. The decision to either transmit or drop a packet is based on the value of the bktcnt register 540 with respect to the value of the threshold register 530. If the value of the bktcnt register 540 is less than or equal to the value of the threshold register 530, then the packet is dropped. If the value of the bktcnt register 540 is higher than the value of the threshold register 530, then the packet is transmitted.

FIG. 7 is a flowchart illustrating a method 700 of controlling packet transmission. In an embodiment of the invention, the bucket engine 600 can execute the method 700. Further, multiple instances of the method 700 can be executed substantially simultaneously or sequentially. First it is determined (710) if a refresh time is up. If the time is up, then the bktcnt for a bucket is incremented (750) to the minimum of the (bktcnt+refhcnt) or bktsize. Next, or if the refresh time is not up, it is determined (720) if a packet has been received after being filtered by a PTF. If a packet has not been received, then the determining (710), incrementing (720) and determining (750) can be repeated as discussed above.

If a packet has been received, then it is determined (730) if bktcnt is greater than the threshold. If the bktcnt is not greater than the threshold, then the packet is dropped (740) or other corrective action is taken (e.g., transmit a pause on packet to the transmitting node). Otherwise, the bktcnt is decremented (760) by the length of the received packet (or decremented by a token in a token bucket system). The packet is then transmitted (770). The method 700 continues until the network switching system is which the method 700 is being executed is turned off. It will appreciated by one of ordinary skill in the art that the method 700 need not be executed in the order recited. For example, determining if a packet (720) has arrived can occur before the determining (710) if the refresh time is up.

Because the system and method described above is executed concurrently with respect to at least two buckets for different types of packets at each port, the transmission behavior of the network switching system using the method 700 is improved over conventional systems. Specifically, the system and method prevents one type of packet from monopolizing a network switching system, which would thereby cause other packets to be dropped. This limits the effects of a broadcast storm and ensures that important packets are not dropped.

For example, if ARP packets are assigned their own bucket at each port, then ARP packets will only get dropped when their bucket falls below a threshold value, indicating an excessive amount of ARP packets over a time period. The number of other types of packets received would be irrelevant and would not effect the transmission of the ARP packets. Further, a network switching system operator can fine-tune the system and method by adjusting the registers 500 to the desired performance. With the conventional system and method, there was only a single bucket that therefore limited the ability of the operator to fine-tune it.

The foregoing description of the illustrated embodiments of the present invention is by way of example only, and other variations and modifications of the above-described embodiments and methods are possible in light of the foregoing teaching. Components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
setting a plurality of packet type filters so that each filters for a different packet type;
incrementing a plurality of buckets, each bucket communicatively coupled to a packet type filter of the plurality of filters;
receiving a packet having a packet type;
measuring the bucket that is coupled to the packet type filter that filters for the received packet type; and
transmitting the packet if its measured bucket is above a threshold value.

2. The method of claim 1, further comprising dropping the packet if the measured bucket is below a threshold value.

3. The method of claim 1, further comprising decrementing the measured bucket if the packet is transmitted.

4. The method of claim 3, wherein the decrementing decrements the measured bucket by a length of the transmitted packet.

5. The method of claim 3, wherein the decrementing decrements the measured bucket by a token.

6. The method of claim 1, wherein the buckets are each incremented at different rates.

7. The method of claim 1, wherein a maximum value for each bucket is different.

8. The method of claim 1, wherein a first packet type includes unicast and a second packet type includes multicast and broadcast.

9. The method of claim 1, wherein a first packet type includes packets having a first QOS level and a second packet type includes packets having a second QOS level.

10. A system, comprising:
means for setting a plurality of packet type filters so that each filters for a different packet type;
means for incrementing a plurality of buckets, each bucket communicatively coupled to a packet type filter of the plurality of filters;
means for receiving a packet having a packet type;
means for measuring the bucket that is coupled to the packet type filter that filters for the received packet type; and
means for transmitting the packet if the measured bucket is above a threshold value.

11. A system, comprising:
a packet receiving engine, capable of receiving packets of at least a first and second type;
a plurality of buckets, each communicatively coupled to the packet receiving engine, each communicatively coupled to a packet type filter of plurality of packet type filters, each packet type filter capable of being set to filter at least one packet type;
a bucket updating engine, communicatively coupled to the packet receiving engine, capable of incrementing a first bucket and a second bucket;
a packet handling engine, communicatively coupled to the packet receiving engine, capable of measuring the bucket coupled to the packet type filter that filters for the type of packet received and capable of transmitting the received packet if the measured bucket is above a threshold value.

12. The system of claim 11, wherein the packet handling engine is further capable of dropping the packet if its measured bucket is below a threshold value.

13. The system of claim 11, wherein the bucket updating engine is further capable of decrementing the measured bucket if the packet is transmitted.

14. The system of claim 13, wherein the bucket updating engine decrements the measured bucket by a length of the transmitted packet.

15. The system of claim 13, wherein the bucket updating engine decrements the measured bucket by a token.

16. The system of claim 13, wherein the bucket updating engine increments each bucket at different rates.

17. The system of claim 11, wherein a maximum value for each bucket is different.

18. The system of claim 11, wherein the first packet type includes unicast and the second packet type includes multicast and broadcast.

19. The system of claim 11, wherein the first packet type includes packets having a first QOS level and the second packet type includes packets having a second QOS level.
